(19) United States
(12) Patent Application Publication
(10) Pub. No.: US 2008/0306714 A1
(43) Pub. Date: Dec. 11, 2008

(54) METHOD FOR DIGITALIZING THREE-DIMENSIONAL COMPONENTS

(75) Inventors: Claudio Ferrarese, Kaisten (CH); Harald Moehlig, Eggingen (DE); Christopher John Hulme, Wuerenlingen (CH); Markus Dietrich, Waldshut-Tiengen (DE)

Correspondence Address: Volpe and Koenig, P.C.;Dept. Alstom, 30 South 17th Street, United Plaza, Suite 1600, Philadelphia, PA, 19103, US

(73) Assignee: ALSTOM TECHNOLOGY LTD., Baden (CH)

(21) Appl. No.: 12/175,751

(22) Filed: Jul. 18, 2008

Related U.S. Application Data
(63) Continuation of application No. PCT/EP2007/050432, filed on Jan. 17, 2007.

(30) Foreign Application Priority Data
Jan. 20, 2006 (CH) 0008906

(51) Int. Cl. G06F 17/50

(52) U.S. Cl. 703/1

(57) ABSTRACT

A three-dimensional component (1) with an external geometry and an internal geometry is digitized in a destructive method. Three-dimensional marking bodies (30) are applied to the outer surface of the body (1). The external geometry of the component (1) with the marking bodies (30) is then digitized using a suitable method and a reference data record is created. The component (1) is disassembled into segments so that all contours of the internal geometry are exposed, after which these segments are digitized. The digital data records of the segments are finally correctly aligned in space and to one another with the aid of the reference data record of the component (1) with the marking geometries (30) and combined. The method is particularly suitable for digitizing components (1) made of materials which are difficult to penetrate with radiation and/or have a high wall thickness.

### CROSS REFERENCE TO RELATED APPLICATIONS

This application is a continuation of International Application No. PCT/EP2007/050432 filed Jan. 17, 2007, which claims priority to Swiss Patent Application No. 00089/06, filed Jan. 20, 2006, the contents of which are incorporated by reference as if fully set forth.

### FIELD OF INVENTION

The invention relates to a method for digitizing three-dimensional components, which have a particular external geometry and a particular internal geometry which is not completely visible from the outside, and, in particular, components which are difficult to penetrate with radiation on account of their material.

### BACKGROUND

The digitization of three-dimensional components is used, inter alia, in the development of components and new production of the same or similar components. If no design data, such as that used for example in CAD (computer aided design), regarding the shape and dimension is available for an existing component to be developed or newly produced, the component is measured to create a three-dimensional data record. For a new production of the component, the data record is used by known production methods such as, for example, CNC (computer numerical control) processing or casting. In the case of a development, also referred to as “re-engineering” or “upgrading”, the component is firstly developed by modifying the three-dimensional data record in a suitable manner and the component is produced according to the modified, new data record.

Digitization methods for the external geometry of a component are known from a number of documents and commercially applied methods. In the case of components with surfaces visible from the outside, a number of spatial coordinates, that is to say three-dimensional data, are recorded and combined to form a virtual model of the component, also known by the term “polygon model”, with the aid of numerical methods.

A known method for recording the external geometry of a component is optical scanning, as disclosed for example in DE 196 139 78. In this case, the surfaces of a component are optically measured from different perspectives, that is to say from different recording positions and at different viewing angles to the outer surface of the component. The measurement in this case is carried out continuously by recording a very high density of measurement points. Subsequently, the recorded individual images are computationally combined to form a three-dimensional, virtual model. In order to permit that the combination of the individual images is also correct, reference markings are applied to the surface of the component prior to the optical measurement. This method assumes that all contours are recognizable along a direct line of sight. However, covered contours, and contours in the shadows, such as, for example, complex contours with undercuts, and, in particular, internal geometries cannot be recorded.

In the case of components with a particular and complex inner structure, such as, for example, a part of a vehicle engine or a part for a gas turbine, which has a particular internal geometry for the purposes of cooling, a particular method is required for determining the external and internal geometry.

In this case, destructive and non-destructive digitization methods are generally differentiated.

A non-destructive method, as is known, for example, from U.S. Pat. No. 5,848,115, comprises the use of computed tomography to record a multiplicity of two-dimensional slice images of the component. A so-called point cloud is generated from the coordinates of the inner and outer surface of the component from the slice images. The application of this method is limited to use on components made of materials that can easily be penetrated by radiation and have a low material density and/or a low wall thickness. However, when applying the method to components which comprise materials that are difficult to penetrate with radiation, and which are even difficult to penetrate for slow or fast neutrons, the computed tomography achieves an insufficient precision of the internal geometry. This occurs, for example, in the case of superalloys based on nickel or cobalt, and other metallic or non-metallic materials having a weight proportion of alloying elements with an atomic weight of over 40 g/mol. Finally, computed tomography can only be used to a limited extent in industry for digitizing components that are difficult to penetrate with radiation due to high costs and large complexity being involved its implementation.

DE 102 41 752 discloses a non-destructive method for three-dimensional, optical measurement of an object by a photogrammetric method, in which a limited number of discrete surface points of the object are measured. A number of images of the external geometry are recorded from different perspectives, that is to say from different positions of the recording machine with respect to the object. For this purpose, the surface of the object to be measured is provided with planar, that is to say two-dimensional, reference markings.

U.S. Pat. No. 5,880,961 discloses a destructive method for the three-dimensional recording of a component. The component to be digitized is molded in a polymer block, such that there is a contrast between the component and the polymer. The polymer block, together with the component, is removed layer by layer, with the contours of the two-dimensional slices or surfaces being digitized after each removal. The removal is carried out without cooling the polymer block. A liquid cooling would make it impossible to record the two-dimensional slice data in a precise manner. Thus, this method can only be applied to components made of materials with a low strength which can be machined without cooling and without large cutting forces being created.

The method cannot be applied to components made of high-strength materials which are difficult to penetrate with radiation on account of their chemical composition.

### SUMMARY

The present invention relates to a method for digitizing external and internal geometries of a three-dimensional component. The method includes arranging three-dimensional marking bodies on an outer surface of the component to be digitized, digitizing, three-dimensionally, the outer surface of the component with the three-dimensional marking bodies and creating a reference data record. The method also includes disassembling the component to be digitized into two or more three-dimensional segments to expose all internal geometries of the component so that all faces of the internal geometry can be acquired along one direct line of sight, digitizing three-dimensionally the two or more three-dimensional segments and creating data records thereof. The data records resulting from the digitization of the segments are combined to form a complete data record which contains data of the complete external and complete internal geometry of the component, with the data records of the three-dimensional segments being aligned in space the three-dimensional marking bodies and the reference data record.

### BRIEF DESCRIPTION OF THE DRAWINGS

FIGS. 1a and 1b show a component to be digitized using the example of a gas turbine blade. Of this, FIG. 1a shows the external geometry of the component and FIG. 1b shows the internal geometry of the component.

FIG. 2 shows the component to be digitized as shown in FIG. 1a having marking bodies attached to the outer surface. In digitized form, this component serves as a reference model for combining the digitized segments according to FIGS. 3a and 3b.

FIG. 3a shows an example of disassembling the component as shown in FIG. 1a into three-dimensional segments, in this example comprising the blade root, the airfoil section of the blade and the blade tip with the blade shroud, with these parts in each case being disassembled along one direction from the blade root to the blade tip.

FIG. 3b shows the intersection line of the disassembling along a cut according to III-III through the component shown in FIG. 3a.

FIG. 4 shows a schematic illustration of the method and computational steps.

### DETAILED DESCRIPTION OF THE PREFERRED EMBODIMENTS

### Introduction to the Embodiments

The present invention is based on the object of creating a method for digitizing three-dimensional components which can also be applied to components with a complex internal geometry and made of materials which are difficult to penetrate with radiation and/or having a high wall thickness. It should be possible to apply the method, inter alia, to components which are exposed to hot gases in gas turbines. In addition, the method should be cost-effective in relation to other known methods.

According to the invention, this object is achieved by a destructive method for three-dimensional digitization comprising the following steps:
Three-dimensional marking bodies, which serve as three-dimensional reference geometries, are arranged on the outer surface of a component to be digitized.
The outer surface of the component, including the three-dimensional marking bodies, is digitized, as a result of which a digitized data record for the outer surface with the marking bodies is formed as a reference model.
The component to be digitized is disassembled into a plurality of three-dimensional segments, so that all faces of the internal geometry are exposed by the individual segments each only having contours which are visible from the outside in a direct line of sight and which can be acquired for the digitization method by an optical recording device.
The three-dimensional segments are digitized in three dimensions by a suitable method, with the data record resulting for each three-dimensional segment in each case comprising data for all surfaces of each segment, including the marking bodies.
The digital three-dimensional data of the three-dimensional segments of the disassembled component are aligned with the aid of the digitized marking bodies to the intact reference model and combined. The three-dimensional marking bodies thus serve for the correct alignment of the segments in space. The six degrees of freedom, that is to say three for translation and three for rotation, are determined for each individual segment.

Expediently, the disassembling of the component is selected in such a way the all the internal geometries are exposed and all contours are directly visible for digitizing and no more undercuts are present.

The marking bodies are in particular attached to those regions of the component which have no or only little change in their contour along one or more Cartesian axial directions or along one of the three rotational directions. This permits an unambiguous, correct alignment of the segments to one another.

Preferably, in each case at least three marking bodies are applied to each of the three-dimensional segments which have small contour changes along one axis or are rotationally-symmetric or mirror-symmetric, in order to ensure an unambiguous alignment of the segments in space.

The method according to the invention is a destructive method, with the part to be digitized only being subdivided into coarse parts and only material having the thickness of the cutting tools being destroyed in the cutting process.

The disassembling serves to make all contours of the component visible that are not directly visible in the intact object, for example parts of a cooling geometry in the interior of the component or contours in an undercut.

The disassembling of the component is carried out using a cutting process, such as wire erosion, that is suitable for the material of the component and the desired size and form of the resultant segments.

If the three-dimensional segments are then digitized individually, they must be digitally recombined. If the component has sections which do not have significant contour changes in a given axial direction, alignment of the individual parts in space and to one another is only possible if supporting data points which permit an unambiguous, correct alignment are present. Marking bodies attached to a digitized reference model of the component, which are arranged on the surface of the reference model, are used for this purpose, with at least three marking bodies being applied to each segment, if applicable, and being contained in the digital data record of the reference model.

Furthermore, in one variant of the method, the reference model is used to digitally fill gaps in the data record which can be traced back to missing material due to the cutting process.

The method according to the invention is particularly suitable for digitizing gas turbine parts which contain a cooling geometry in the interior. The method is also suitable for other components, such as, for example, parts of a vehicle, in particular an engine having cooling channels, for example.

The method according to the invention is particularly suitable for digitizing components made from materials which have a high density and thus can only be penetrated with difficulty by high-energy radiation. It is suitable for components which can only be penetrated with difficulty by high-energy radiation due to the density of their material and/or their wall thickness. In particular, the method is suitable for components made from nickel- or cobalt-based superalloys, with any arbitrary morphology of their microstructure, that is to say single crystalline, directionally solidified or polycrystalline. Furthermore, the method is suitable for components having a high wall thickness and made of an arbitrary material, as well as for components made of ferrous materials, such as, for example, steel, cast steel or cast iron. It is suitable for components of non-ferrous metals, such as, for example, aluminum, magnesium, titanium, and alloys of these metals.

The method according to the invention requires that the disassembling of the components is performed in such a way that the resultant three-dimensional segments each contain at least one section which is a part of the outer surface of the originally intact component.

The marking bodies can have an arbitrary, suitable shape. By way of example, they can be designed in the shape of a cylinder, cone or pyramid. However, in any case they have to be three-dimensional and as such protrude from the outer surface of the component to permit a correct alignment of the parts in space.

### DETAILED DESCRIPTION

The method according to the invention will be explained on the basis of the digitization of a commercially available gas turbine blade.

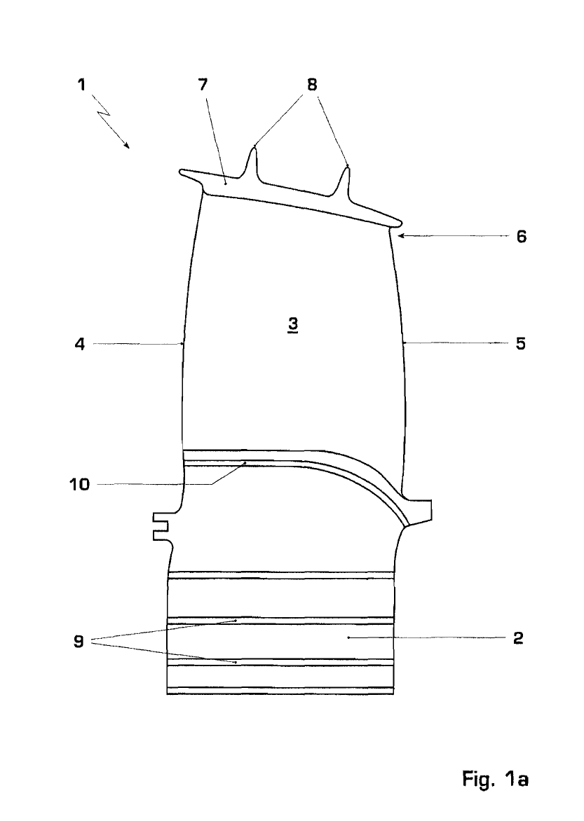

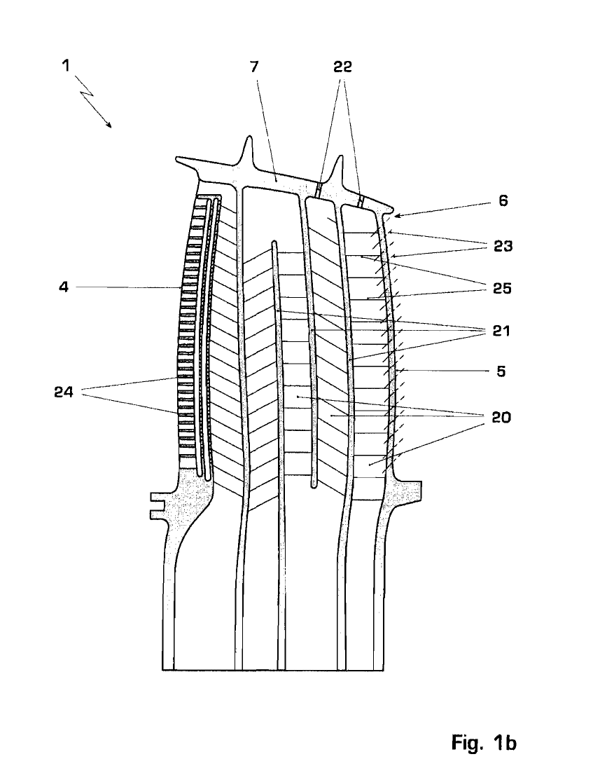

FIG. 1a is a side view of a gas turbine blade 1 comprising a blade root 2, an airfoil section 3 of the blade, which has a trailing edge 4 and a leading edge 5, and a blade shroud 7 with edges 8 on a blade tip 6. The blade root 2 is designed in the form of a fir tree and has a plurality of bulges 9 and a groove 10. By way of example, the airfoil section 3 can be designed to be straight or curved along its longitudinal extent, and/or can have a twist along the longitudinal axis of its blade.

FIG. 1b shows the internal geometry of the gas turbine blade 1 shown in FIG. 1a, which is exposed by a longitudinal cut along a longitudinal axis of the blade which is approximately parallel to the face of the airfoil section. The internal geometry has a plurality of cooling channels 20, which are formed either by the leading edge 5 or trailing edge 4 and a channel wall 21, or by two channel walls 21. The channel walls 21 extend from the region of the blade tip 6 to the blade root end that lies opposite from the blade tip. Exhaust holes 22 lead out of the blade from the cooling channels 20 via the blade shroud 7. Likewise, cooling channels 23, 24 lead to the outer surface of the airfoil section at the trailing and leading edges 4, 5. Finally, the cooling channels 21 are provided with ribs 25.

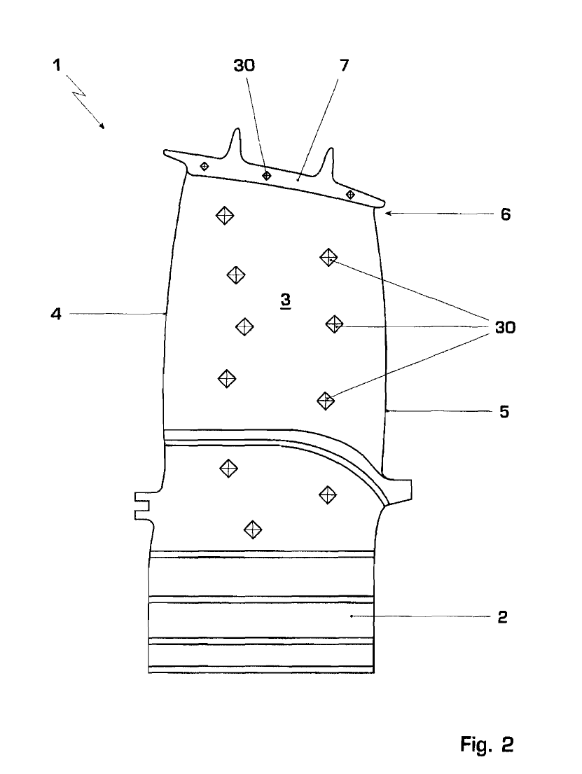

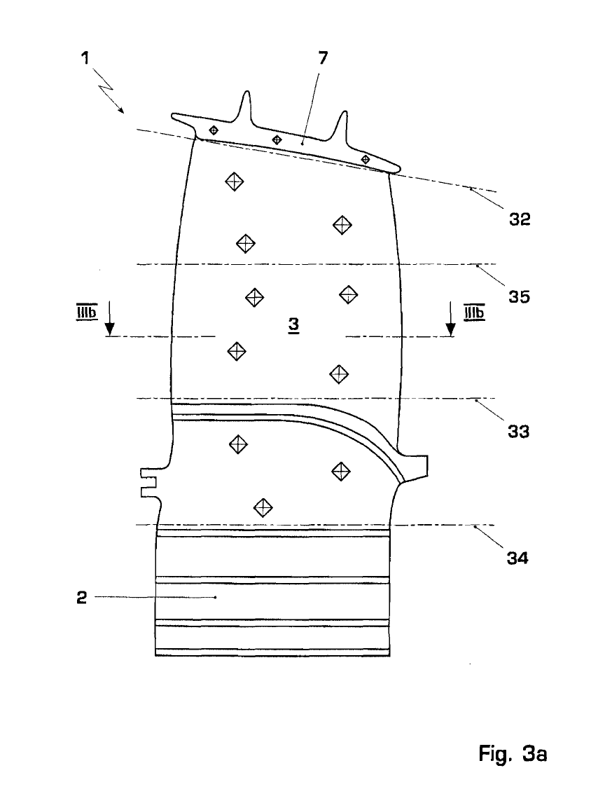

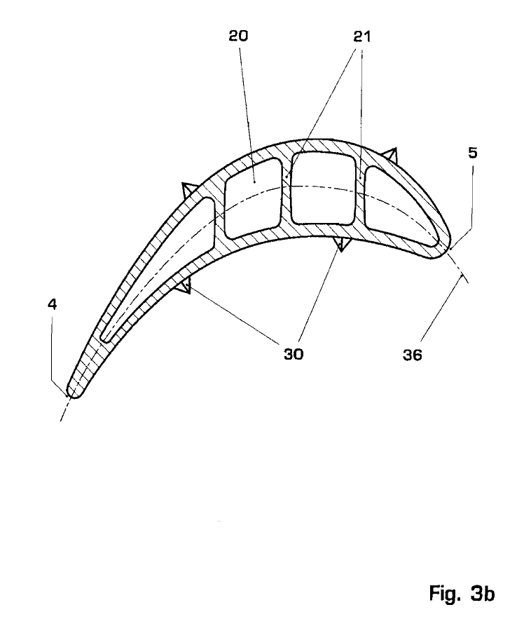

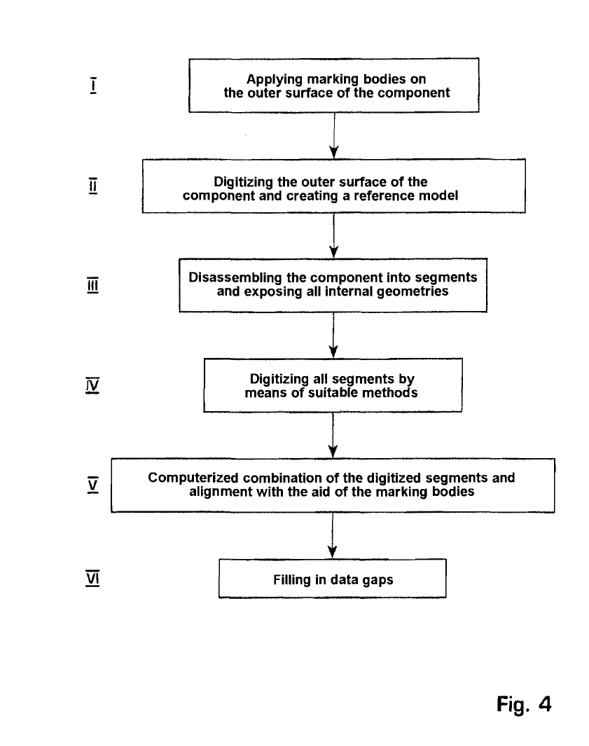

FIG. 4 schematically illustrates the stepwise procedure of the digitization method according to the invention. Steps I and III correspond to FIGS. 2, 3a and 3b, which are described in the following.

FIG. 2 shows the gas turbine blade 1 as shown in FIG. 1a, to which a plurality of marking bodies 30 have been attached in this case to the blade shroud 6, airfoil section 3 and blade root 2, according to step I in FIG. 4. In this case, the marking bodies 30 are designed in the form of a pyramid. The method according to the invention for digitizing the component assumes that a marking body is of a three-dimensional design, and protrudes from the surface of the component. As such, a marking body 30 may also be designed, for example, in the form of a cylinder, cone, cuboid, sphere or hemisphere, or can have any other three-dimensional shape suitable for being produced simply and to being attached to the outer surface. It is also possible to use recesses as marking bodies, for example a recess tapering at its end, a groove, a bore or a counterbore. However, it is preferable that the marking bodies or marking recesses are not rotationally symmetric.

In the case of the method according to the invention, the component to be digitized is first of all provided with marking bodies. In this case, they are attached to those sections of the component which have only a small change, or no change at all, on a given partial area of the outer surface along one of the three axial directions in space or along one of the three rotational directions. These sections could otherwise not be aligned unambiguously with respect to an adjacent section. In the exemplary case of a gas turbine blade, the marking bodies are to be applied particularly to the airfoil section.

In a preferred variant of the method, the marking bodies are applied in such a way that the three-dimensional segments resulting from the disassembling of the component are of sufficient number to ensure an unambiguous alignment of the segments. The alignment is implemented with the aid of the marking bodies, but it can also additionally be implemented with the aid of geometric features present on the segments. Such geometric features can reduce the number of marking bodies required.

In a further preferred variant of the method, the marking bodies are distributed on the surface of the body in such a way that the spatial distance between them is as large as possible and, as far as possible, the marking bodies do not lie in one line.

According to step II as shown in FIG. 4, the outer surface of the component including all the marking bodies is digitized in three dimensions according to the invention. By way of example, the digitization is carried out by optical scanners. For this purpose, a chosen section of the outer surface is optically acquired from different positions by digital cameras. This step on its own is standard practice. However, it is also possible to use different known digitizing methods for this step II, such as, for example, laser-scanning or coordinate-measurement methods working in a manner based on contact.

Every suitable digitization method generates a so-called point cloud of the component in space. Each point of this point cloud has three spatial coordinates. Depending on the resolution of the chosen method, this results in a coarser or less coarse image of the three-dimensional component. However, this image has no surface. The surface of the component is reconstructed by so-called polygonizing, that is to say a connection of a given number of points by a polygon that has just as many corners. In general, triangles are used in this method, so this is also referred to as triangulation.

FIGS. 3a and 3b show an example of disassembling the component to be digitized into three-dimensional parts according to step III.

As a next step III, the gas turbine blade 1 is disassembled along the dashed lines 32-36 into a plurality of three-dimensional segments, for example by wire erosion cutting (EDM), water jet cutting or a further suitable cutting method, so that the entire internal geometry of the blade is disclosed and can be acquired along direct lines of sight. The number of disassembling cuts through the blade required depends on the degree of twisting and curvature of the blade along the longitudinal axis, and the geometry of the inner cooling channels. After disassembling, no contours of the internal geometry may remain covered. The cuts along lines 32, 35 and 36 expose the cooling geometry of the blade shroud 7 with the exhaust holes 22 and the airfoil section 3 with the cooling channel walls 21 and cooling channels 21, 23, 24, with the cuts along lines 33 and 34 exposing the cooling channels in the blade root 2.

Preferably, each segment with few geometric features aiding the alignment has at least three marking bodies 30.

According to step IV, all the blade segments including the marking bodies resulting from the disassembling are then digitized in three dimensions, preferably by the same method used in step II.

According to step V, the data records of all three-dimensional segments are combined computationally. The marking bodies are now used to correctly align the three-dimensional segments in space by the spatial position being made to coincide with the digitized model of the intact blade, that is to say the reference model from step II. After the correct alignment of the three-dimensional segments, the three-dimensional, virtual reference model can be deleted.

In a variant of the method according to the invention, the sections of the component which were destroyed by the cutting process and are missing from the segments are finally reproduced in an additional step VI. For this purpose, faces newly created by disassembling the component first have to be deleted so that subsequently the gaps can be reconnected to the individual segments based on area considerations.

### LIST OF REFERENCE SYMBOLS

1 Gas turbine blade
2 Blade root
3 Airfoil section of the blade
4 Trailing edge of the blade
5 Leading edge of the blade
6 Tip of the blade
7 Blade shroud
8 Edges
9 Bulges
10 Groove
20 Cooling channels
21 Channel walls
22 Exhaust holes
23, 24 Cooling channels
25 Ribs
32-36 Cut lines of the disassembling of the component

What is claimed is:

1. A method for digitizing external and internal geometries of a three-dimensional component (1) comprising:
arranging three-dimensional marking bodies (30) on an outer surface of the component (1) to be digitized,
digitizing, three-dimensionally, the outer surface of the component (1) with the three-dimensional marking bodies (30) and creating a reference data record,
disassembling the component (1) to be digitized into two or more three-dimensional segments to expose all internal geometries of the component (1) so that all faces of the internal geometry can be acquired along one direct line of sight,
digitizing, three-dimensionally, the two or more three-dimensional segments and creating data records thereof,
combining the data records resulting from the digitization of the segments to form a complete data record which contains data of the complete external and complete internal geometry of the component (1), with the data records of the three-dimensional segments being aligned in space the three-dimensional marking bodies (30) and the reference data record.

2. The method as claimed in claim 1, wherein the three-dimensional marking bodies (30) are arranged in regions of the component (1) which have little to no change in their contour along one or more Cartesian axial directions or along one of the three rotational directions.

3. The method as claimed in claim 1, wherein the three-dimensional marking bodies (30) are distributed and arranged on the outer surface of the component (1) in such a way that each of the three-dimensional segments is unambiguously alignable.

4. The method as claimed in claim 1, wherein the disassembling of the body into three-dimensional segments is carried out by wire erosion, water jet cutting or another suitable cutting process.

5. The method as claimed in claim 1, wherein each resultant three-dimensional segment has at least a part of the outer surface of the component (1).

6. The method as claimed in claim 1, wherein the marking bodies (30) are designed in the shape of a pyramid, cylinder, cone, cuboid, sphere, hemisphere, or as a recess.

7. The method as claimed in claim 6, wherein the marking bodies (30) are designed to protrude from the outer surface of the component (1).

8. The method as claimed in claim 1, wherein the marking bodies (30) are designed as a recess in the outer surface of the component (1).

9. The method as claimed in claim 1, wherein the three-dimensional component to be digitized is made of a material which has a high density or which is difficult to penetrate with high-energy radiation.

10. The method as claimed in claim 1, wherein the three-dimensional component to be digitized is made from a material comprising nickel- or cobalt-based alloys.

11. The method as claimed in claim 1, wherein the three-dimensional component to be digitized is made from a material comprising ferrous materials.

12. The method as claimed in claim 1, wherein the three-dimensional component to be digitized is made from a material comprising non-ferrous metals.

13. The method as claimed in claim 1, wherein the three-dimensional component to be digitized is a component of a gas turbine.
